(19) United States
(12) Patent Application Publication
(10) Pub. No.: US 2016/0252029 A1
(43) Pub. Date: Sep. 1, 2016

(54) AFTERTREATMENT CONTROL SYSTEM

(71) Applicant: Caterpillar Inc., Peoria, IL (US)

(72) Inventor: Douglas Michael Biagini, Washington, IL (US)

(73) Assignee: Caterpillar Inc., Peoria, IL (US)

(21) Appl. No.: 15/149,728

(22) Filed: May 9, 2016

(51) Int. Cl. F02D 41/02; F01N 13/00; F01N 11/00

(52) U.S. Cl. CPC F02D 41/0245; F01N 11/002; F01N 13/002

(57) ABSTRACT

An aftertreatment control system for an engine is illustrated. The aftertreatment control system includes a first temperature sensor configured to generate a signal indicative of a temperature at an inlet of an aftertreatment system and a second temperature sensor configured to generate a signal indicative of an ambient temperature. The aftertreatment control system also includes a throttle position sensor configured to generate a signal indicative of a position of a throttle associated with the engine. The aftertreatment control system includes a controller coupled to the first temperature sensor, the second temperature sensor, the throttle position sensor, and the engine. The controller is configured to regulate, selectively, a power output of the engine based, at least in part, on the temperature at the inlet of the aftertreatment system, the ambient temperature, the position of the throttle, and a determined time period indicative of an operational time of the engine.

### TECHNICAL FIELD

The present disclosure relates to an aftertreatment control system. More particularly, the present disclosure relates to the aftertreatment control system for an engine.

### BACKGROUND

Engines employ an aftertreatment system to treat exhaust gases generated by the engine before being released into atmosphere. During low ambient temperature conditions, a temperature of the aftertreatment system may also be low. In such conditions, during engine operation, the aftertreatment system may receive hot exhaust gases resulting in a sudden rise in temperature of the aftertreatment system. As a result, the aftertreatment system may experience increased thermal stress leading to damage and/or failure of the aftertreatment system.

Also, in low ambient temperature conditions, during cold start of the engine, the exhaust gases may contain a relatively higher amount of hydrocarbons. The hydrocarbons may be received in the aftertreatment system. Due to low temperature of the aftertreatment system, the hydrocarbons received therein may deposit and accumulate on components of the aftertreatment system such as a catalytic converter. As the aftertreatment system may be heated due to continuous operation of the engine, a rise in temperature may result in sudden burning of the accumulated hydrocarbons. This in turn may lead to an exothermic reaction within the aftertreatment system resulting in excessive temperature and thermal stress within the aftertreatment system. The excessive temperature and the thermal stress may further damage components of the aftertreatment system.

U.S. Pat. No. 5,390,491 describes an ignition timing control system for an internal combustion engine. The system is configured to perform fast catalyst warm-up operation and prevent stalling at a restart of the internal combustion engine at a low temperature. The system judges whether the engine is in a start state or not. The system also judges whether a cooling water temperature is lower than a specified temperature or not. The system further judges whether an intake air temperature is higher than a preset temperature or not. When these judgments are all affirmative, the system further judges Whether a. time after the start has reached a control starting time or not, and then whether the engine is in an idle operation state or not. When these judgments are both affirmative, the system sets a target ignition timing retard amount and an ignition timing gradual change time according to the intake air temperature. The system then performs the ignition timing control according to the target retard amount and the gradual retard time. Alternatively, the control system judges deterioration state of a catalyst and controls the ignition timing in dependence on the catalyst deterioration state and the intake air temperature.

### SUMMARY OF THE DISCLOSURE

In an aspect of the present disclosure, an aftertreatment control system for an engine is illustrated. The aftertreatment control system includes a first temperature sensor configured to generate a signal indicative of a temperature at an inlet of an aftertreatment system of the engine. The aftertreatment control system includes a second temperature sensor configured to generate a signal indicative of an ambient temperature. The aftertreatment control system also includes a throttle position sensor configured to generate a signal indicative of a position of a throttle associated with the engine. The aftertreatment control system further includes a controller coupled to the first temperature sensor, the second temperature sensor, the throttle position sensor, and the engine. The controller is configured to receive the signal indicative of the temperature at the inlet of the aftertreatment system. The controller is configured to receive the signal indicative of the ambient temperature. The controller is configured to receive the signal indicative of the position of the throttle. The controller is also configured to determine a time period indicative of an operational time of the engine. The controller is further configured to regulate, selectively, a power output of the engine based, at least in part, on the temperature at the inlet of the aftertreatment system. the ambient temperature, the position of the throttle, and the time period.

Other features and aspects of this disclosure will be apparent from the following description and the accompanying drawings.

### BRIEF DESCRIPTION OF THE DRAWINGS

FIG. 1 is a side perspective view of an exemplary machine, according to one embodiment of the present disclosure;

FIG. 2 is a schematic representation of an aftertreatment control system for the machine of FIG. 1, according to one embodiment of the present disclosure;

FIG. 3 is a flowchart illustrating a method of working of the aftertreatment control system of FIG. 2, according to one embodiment of the present disclosure; and

FIG. 4 is an exemplary ramp rate map, according to one embodiment of the present disclosure.

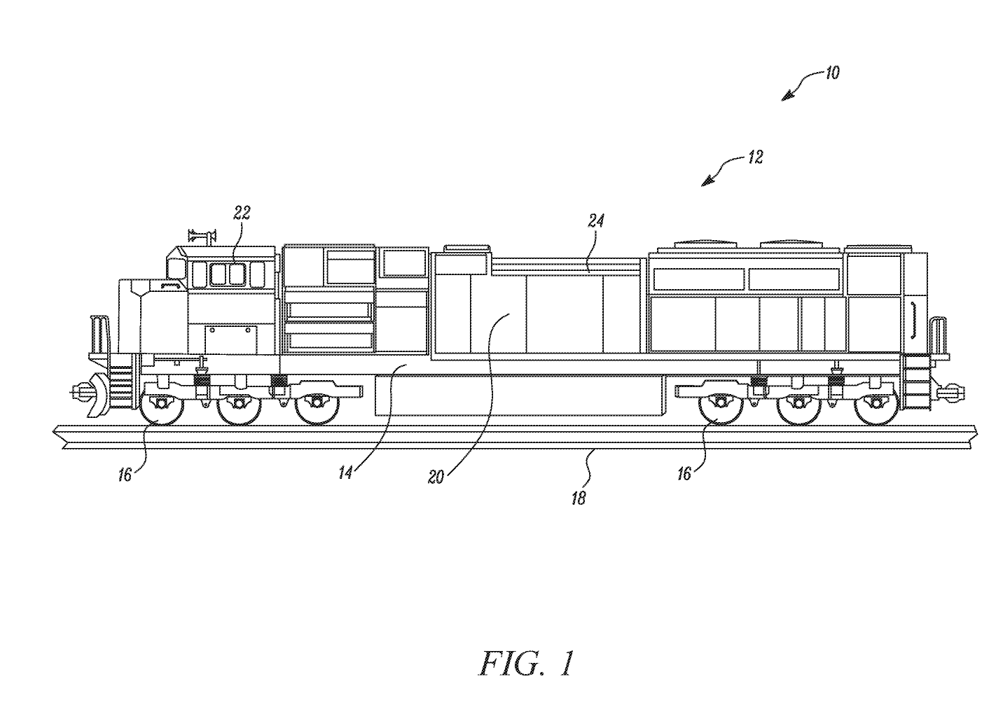

### DETAILED DESCRIPTION

Wherever possible, the same reference numbers will be used throughout the drawings to refer to the same or the like parts. Referring to FIG. 1, an exemplary machine 10 is illustrated. More specifically, the machine 10 is a locomotive 12. In other embodiments, the machine 10 may be any other machine such as a mining truck, a dozer, a wheel loader, a crane, a marine vessel, a power generator, and so on. The machine 10 may be any machine associated with an industry including, but not limited to, construction, transportation, agriculture, aviation, marine, material handling, waste management, and power generation.

The locomotive 12 includes a frame 14. The frame 14 supports one or more components of the locomotive 12. The locomotive 12 includes a set of wheels 16 mounted to the frame 14. The wheels 16 support and provide mobility to the locomotive 12 on a set of rails 18. The locomotive 12 includes an enclosure 20 mounted on the frame 14. The enclosure 20 houses one or more components (not shown) provided on the frame 14 of the locomotive 12.

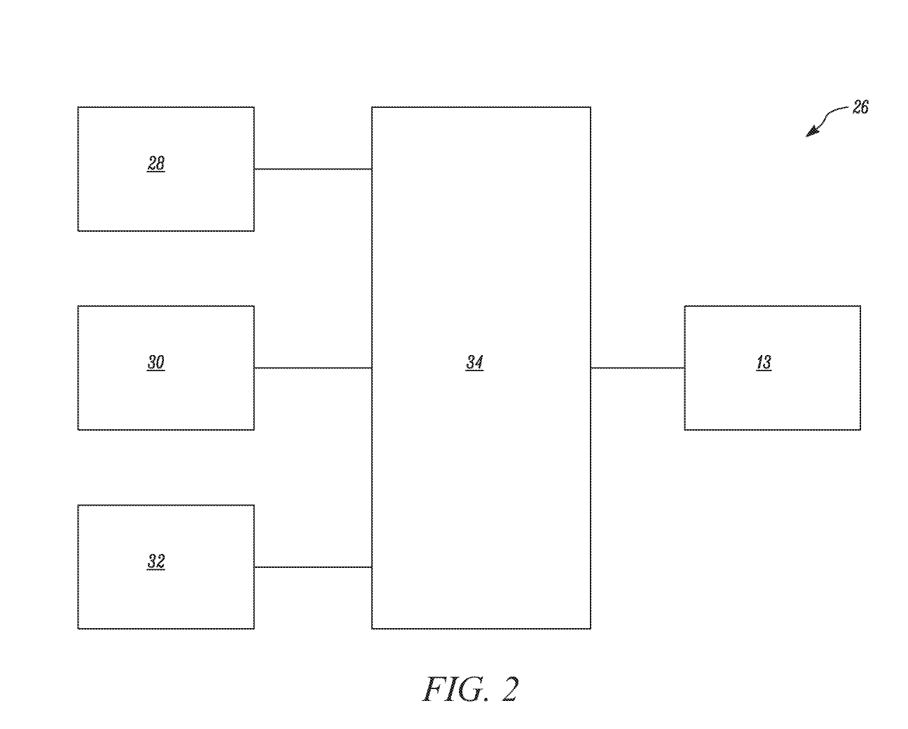

The locomotive 12 may include an engine 13 (shown in FIG. 2) provided on the frame 14 and within the enclosure 20. The engine 13 may be an internal combustion engine or a gas turbine. The engine 13 may be powered by any fuel known in the art such as diesel, gasoline, natural gas, and so on, or a combination thereof The engine 13 may generate mechanical power.

The locomotive 12 may include a generator, also known as a traction alternator, provided on the frame 14 and within the enclosure 20. The generator may be mechanically coupled to the engine 13. The generator may receive the mechanical power from the engine 13 and may generate electrical power.

The locomotive 12 may also include an electric motor, also known as a traction motor, provided on the frame 14 and within the enclosure 20. The electric motor may be electrically coupled to the generator. The electric motor may be further coupled to the wheels 16. The electric motor may receive the electrical power from the generator and may provide motive power to the wheels 16 of the locomotive 12. Also, the locomotive 12 may include a transmission system coupled between the electric motor and the wheels 16. The transmission system may include various components such as gears, bearings, shafts, axles, and so on. The transmission system may transfer the motive power from the electric motor to the wheels 16.

The locomotive 12 also includes an operator cabin 22 provided on the frame 14. The operator cabin 22 may house various controls of the locomotive 12 including, but not limited to, levers, pedals, joysticks, buttons, a control interface, audio video devices, a communication system, and an operator seat. The controls may be configured to operate and control the locomotive 12.

Additionally, the locomotive 12 may include various components and/or systems (not shown) provided on the frame 14 and/or within the enclosure 20 such as a fuel delivery system, an air supply system, a cooling system, a lubrication system, an electrical/electronic control system, a rectifier, an inverter, batteries, a safety system, a drive control system, a brake control system, a turbocharger, an exhaust gas recirculation system, a regenerative braking system, peripheries, and so on based on application requirements without limiting the scope of the disclosure.

The locomotive 12 also includes an aftertreatment system 24 provided on the frame 14 of the machine 10. The aftertreatment system 24 is coupled to the engine 13. Accordingly, the aftertreatment system 24 may receive exhaust gases generated by the engine 13. The aftertreatment system 24 treats the exhaust gases before being released into the atmosphere. The aftertreatment system 24 may include a number of components (not shown) such as a Diesel Oxidation Catalyst (DOC), a Diesel Particulate Filter (DPF), a reductant injection system, a mixer, a Selective Catalytic Reduction (SCR) unit, and so on based on application requirements.

Referring to FIG. 2, a schematic representation of an aftertreatment control system 26 is illustrated. The aftertreatment control system 26 includes a first temperature sensor 28. The first temperature sensor 28 is coupled to an inlet (not shown) of the aftertreatment system 24. More specifically, the first temperature sensor 28 may be coupled to an inlet of the DOC, an inlet of the DPF, an inlet of the mixer, and inlet of the SCR unit, and so on without limiting the scope of the disclosure. The first temperature sensor 28 is configured to generate a signal indicative of a temperature at the inlet of the aftertreatment system 24. More specifically, the first temperature sensor 28 is configured to generate a signal indicative of a temperature of the exhaust gases received at the inlet of the aftertreatment system 24.

The aftertreatment control system 26 includes a second temperature sensor 30. The second temperature sensor 30 is configured to generate a signal indicative of an ambient temperature. Accordingly, the second temperature sensor 30 may be coupled to the frame 14 and/or the enclosure 20 of the machine 10, an intake manifold (not shown) of the engine 13, or any other location on the machine 10 such that the second temperature sensor 30 may be in contact with the ambient air. Each of the first temperature sensor 28 and the second temperature sensor 30 may be any temperature sensor known in the art such as a thermocouple, a thermistor, a resistive temperature detector, an infrared type temperature sensor, and so on.

The aftertreatment control system 26 also includes a throttle position sensor 32. The throttle position sensor 32 is coupled to a throttle (not shown) associated with the engine 13 of the locomotive 12. The throttle position sensor 32 may be any throttle position sensor known in the art such as a hall effect type throttle position sensor, an inductive type throttle position sensor, a magnetoresistive type throttle position sensor, a potentiometric type throttle position sensor, and so on.

The aftertreatment control system 26 further includes a controller 34, The controller 34 is coupled to the first temperature sensor 28, the second temperature sensor 30, the throttle position sensor 32, and the engine 13. The controller 34 is configured to receive the signal indicative of the temperature at the inlet of the aftertreatment system 24 from the first temperature sensor 28. The controller 34 is configured to receive the signal indicative of the ambient temperature from the second temperature sensor 30.

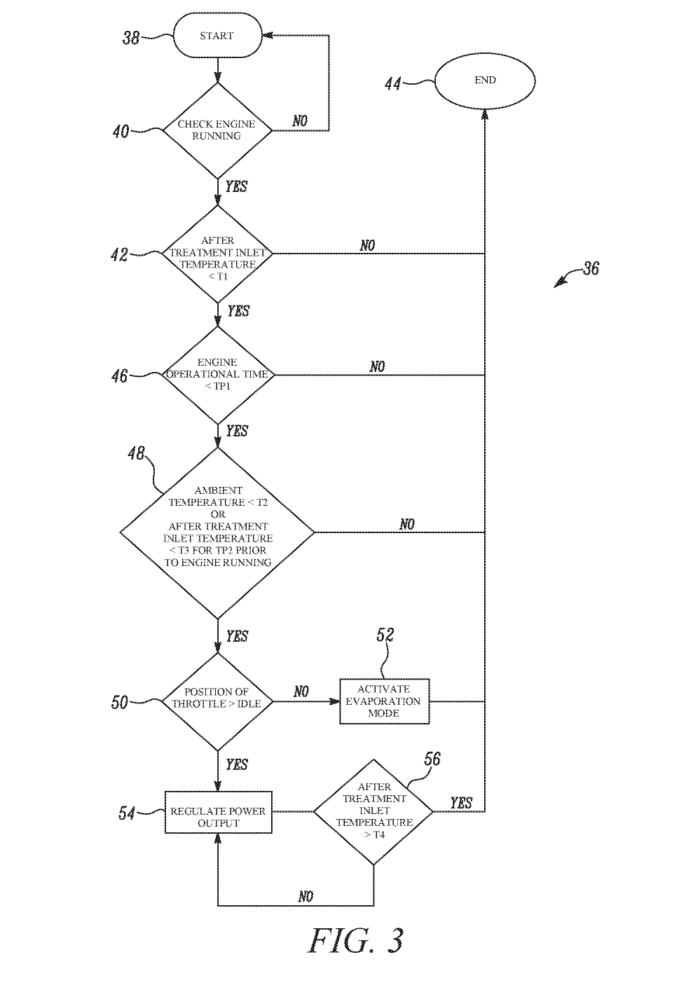

The controller 34 is configured to receive the signal indicative of the position of the throttle from the throttle position sensor 32. The controller 34 is also configured to determine a time period indicative of an operational time of the engine 13. The controller 34 is further configured to selectively regulate a power output of the engine 13 based, at least in part, on the temperature at the inlet of the aftertreatment system 24, the ambient temperature, the position of the throttle, and the time period. In some situations, the controller 34 may also be configured to activate an evaporation mode of the aftertreatment system 24 based on the signal indicative of the position of the throttle. The working of the aftertreatment control system 26 will be explained in detail with reference to FIG. 3.

### INDUSTRIAL APPLICABILITY

The present disclosure relates to the aftertreatment control system 26. Referring to FIG. 3, a flowchart of a method 36 of working of the aftertreatment control system 26 is illustrated. At step 38, the controller 34 starts an aftertreatment control strategy. The controller 34 is then configured to proceed to step 40. At step 40, the controller 34 is configured to check for an operational state of the engine 13. More specifically, the controller 34 is configured to check if the engine 13 is running. If the condition at step 40 is false, the controller 34 is configured to route back to step 38. If the condition at step 40 is true, the controller 34 is configured to proceed to step 42. At step 42, the controller 34 is configured to check if the temperature at the inlet of the aftertreatment system 24 is lower than a first predetermined temperature value (T1). The first predetermined temperature value (T1) may include any value based on application requirements and may be stored in a memory (not shown) of the controller 34 or a database (not shown) coupled to the controller 34.

If the condition at step 42 is false, the controller 34 is configured to proceed to step 44. At step 44, the controller 34 is configured to end the aftertreatment control strategy. If the condition at step 42 is true, the controller 34 is configured to proceed to step 46. At step 46, the controller 34 is configured to check if the operational time of the engine 13 is lower than a first predetermined time period (TP1). The first predetermined time period (TP1) may include any value based on application requirements and may be stored in the memory of the controller 34 or the database. If the condition at step 46 is false, the controller 34 is configured to proceed to step 44 in order to end the aftertreatment control strategy.

If the condition at step 46 is true, the controller 34 is configured to proceed to step 48. At step 48, the controller 34 is configured to check if the ambient temperature is lower than a second predetermined temperature value (T2). The second predetermined temperature value (T2) may include any value based on application requirements and may be stored in the memory of the controller 34 or the database. At step 48, the controller 34 is also configured to check if the temperature at the inlet of the aftertreatment system 24 is lower than a third predetermined temperature value (T3) for a second predetermined time period (TP2) prior to running of the engine 13. The third predetermined temperature value (T3) and the second predetermined time period (TP2) may include any values based on application requirements and may be stored in the memory of the controller 34 or the database.

If both the conditions at step 48 are false, the controller 34 is configured to proceed to step 44 in order to end the aftertreatment control strategy. If any of the condition at step 48 is true, the controller 34 is configured to proceed to step 50. At step 50, the controller 34 is configured to check if the position of the throttle is greater than an idle position thereof. If the condition at step 50 is false, the controller 34 is configured to proceed to step 52. At step 52, the controller 34 is configured to activate an evaporation mode of the aftertreatment system 24. Further, the controller 34 is configured to proceed to step 44 in order to end the aftertreatment control strategy.

The evaporation mode may be any evaporation mode known in the art configured to gradually increase a temperature of the aftertreatment system 24 in order to bum or evaporate a deposition of exhaust gas constituents therein such as hydrocarbons, particulate matter, and so on in a controlled manner. In some embodiments, the evaporation mode may include inducing a temporary parasitic load on the engine 13. The parasitic load may temporarily increase one or more operating conditions of the engine 13 in order to increase the temperature of the exhaust gases and in turn the temperature of the aftertreatment system 24. In some embodiments, the evaporation mode may include activating one or more auxiliary heaters associated with the aftertreatment system 24. The auxiliary heaters may temporarily increase the temperature of the aftertreatment system 24 based on an operational state thereof.

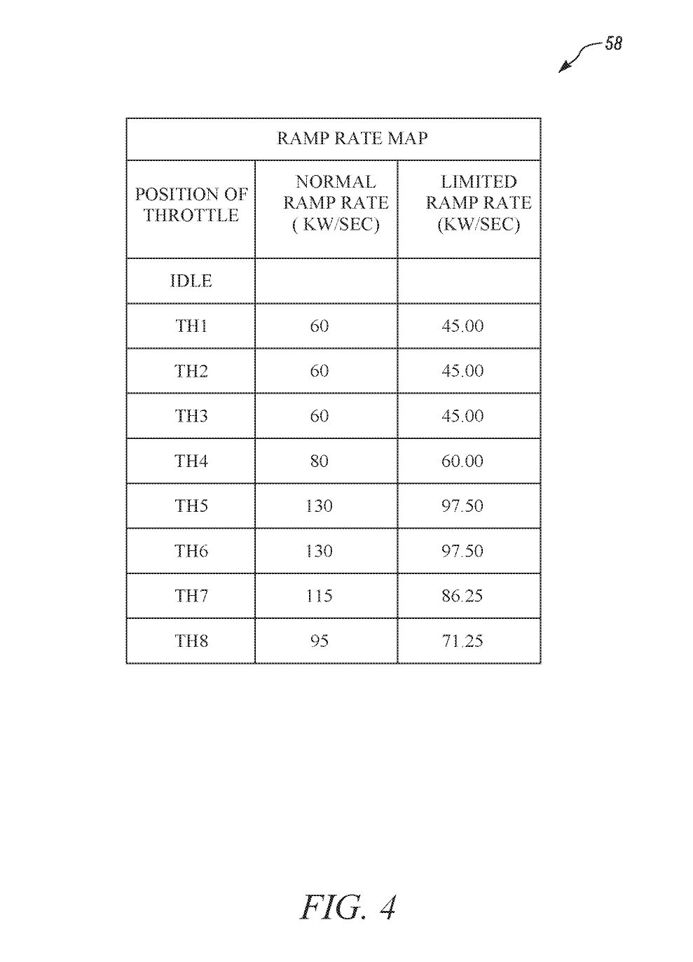

If the condition at step 50 is true, the controller 34 is configured to proceed to step 54. At step 54, the controller 34 is configured to regulate a power output of the engine 13. The controller 34 is configured to regulate the power output of the engine 13 based on a ramp rate map 58 (shown in FIG. 4). The ramp rate map 58 may be stored in the memory of the controller 34 or the database. The ramp rate map 58 may include values of the power output (limited ramp rate) for different positions of the throttle.

Referring to FIG. 4, the exemplary ramp rate map 58 is illustrated. For example, in a normal operating condition of the engine 13, at a first position TH1 of the throttle, the controller 34 is configured to limit the power output of the engine 13 to 60 Kilowatt per Second (kW/s) based on a normal ramp rate. When the ramp rate map 58 is activated, at the first position TH1 of the throttle, the controller 34 is configured to limit the power output of the engine 13 to 45 kW/s based on a limited ramp rate. More specifically, when the ramp rate map 58 is activated, the controller 34 is configured to limit the power output of the engine 13 to a percentage of the normal ramp rate for corresponding position of the throttle.

Similarly, in the normal operating condition of the engine 13, at a fourth position TH4 of the throttle, the controller 34 is configured to limit the power output of the engine 13 to 80 kW/s based on the normal ramp rate. When the ramp rate map 58 is activated, at the fourth position TH4 of the throttle, the controller 34 is configured to limit the power output of the engine 13 to 60 kW/s based on the limited ramp rate. Similarly, in the normal operating condition of the engine 13, at an eighth position TH8 of the throttle, the controller 34 is configured to limit the power output of the engine 13 to 95 kW/s based on the normal ramp rate. When the ramp rate map 58 is activated, at the eighth position TH8 of the throttle, the controller 34 is configured to limit the power output of the engine 13 to 71.25 kW/s based on the limited ramp rate. It should be noted that a number of positions of the throttle, the values of the normal ramp rate, the values of the limited ramp rate, a difference between the values of the normal ramp rate and the limited ramp rate, and so on disclosed herein is merely exemplary and may vary based on application requirements.

Referring to FIG. 3, the controller 34 is further configured to proceed to step 56. At step 56, the controller 34 is configured to check if the temperature at the inlet of the aftertreatment system 24 is higher than a fourth predetermined temperature value (T4). The fourth predetermined temperature value (T4) may include any value based on application requirements and may he stored in the memory of the controller 34 or the database. If the condition at step 56 is false, the controller 34 is configured to route back to step 54 and continue to regulate the power output of the engine 13 based on the ramp rate map 58. If the condition at step 56 is true, the controller 34 is configured to proceed to step 44 in order to end the aftertreatment control strategy.

The aftertreatment control system 26 provides a simple, efficient, cost effective method for controlling the aftertreatment system 24 in order to limit thermal stress, exothermic reactions, and so on therein. The aftertreatment control system 26 may be employed in any aftertreatment system 24 with no or minor modifications to the existing system. The aftertreatment control system 26 may employ existing components of the system such as the first temperature sensor 28, the second temperature sensor 30, the throttle position sensor 32, the controller 34, and so on thus reducing an overall system cost.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. An aftertreatment control system for an engine, the aftertreatment control system comprising:
a first temperature sensor configured to generate a signal indicative of a temperature at an inlet of an aftertreatment system;
a second temperature sensor configured to generate a signal indicative of an ambient temperature;
a throttle position sensor configured to generate a signal indicative of a position of a throttle associated with the engine, and
a controller coupled to the first temperature sensor, the second temperature sensor, the throttle position sensor, and the engine, the controller configured to:
receive the signal indicative of the temperature at the inlet of the aftertreatment system;
receive the signal indicative of the ambient temperature;
receive the signal indicative of the position of the throttle;
determine a time period indicative of an operational time of the engine; and
regulate, selectively, a power output of the engine based, at least in part, on the temperature at the inlet of the aftertreatment system, the ambient temperature, the position of the throttle, and the time period.

2. The aftertreatment control system of claim 1, wherein the controller is further configured to activate an evaporation mode of the aftertreatment system based on the signal indicative of the position of the throttle.
